(19) United States
(12) Patent Application Publication
(10) Pub. No.: US 2026/0292342 A1
(43) Pub. Date: Sep. 24, 2026

(54) SYSTEM AND METHOD FOR PREVENTING BLOCKAGE IN FIELD OF VIEW OF SENSING DEVICE

(71) Applicant: AUMOVIO Autonomous Mobility Germany GmbH, Ingolstadt (DE)

(72) Inventors: Bhanu Prakash Padiri, Bangalore (IN); Stefan Christmann, Geislingen an der Steige (DE)

(73) Assignee: AUMOVIO Autonomous Mobility Germany GmbH, Ingolstadt (DE)

(21) Appl. No.: 19/549,141

(22) Filed: Feb. 25, 2026

(30) Foreign Application Priority Data
Mar. 20, 2025 (GB) 2504082.5

(51) Int. Cl. H04N 23/695; H04N 17/00

(52) U.S. Cl. CPC H04N 23/695; H04N 17/002

(57) ABSTRACT

A method for preventing a blockage in a field of view while capturing visual data is disclosed. The method including detecting the blockage in the field of view of a sensing device when the sensing device captures the visual data. The method further including determining a plurality of attributes associated with the blockage. The method further includes determining an image planar adjustment action based on at least one attribute of the plurality of attributes. The image planar adjustment action includes an image planar adjustment and an image planar non-adjustment based on a threshold range associated with the at least one attribute.

### CROSS-REFERENCE TO RELATED APPLICATIONS

This application claims priority under 35 U.S.C. § 119 to GB Patent Application No. 2504082.5 filed on Mar. 20, 2025, the entire disclosure of which is incorporated by reference herein.

### FIELD OF THE INVENTION

The present disclosure in general relates to system and method for preventing blockage. More particularly, the present disclosure relates to a system and a method for preventing a blockage in a field of view of a sensing device that is disposed on a vehicle.

### BACKGROUND OF THE INVENTION

Modern vehicles increasingly rely on advanced driver assistance systems (ADAS) that utilize various sensors, including cameras, to enable functionalities such as object detection, lane keeping, and collision avoidance. These sensors, however, are susceptible to environmental and physical conditions that can degrade their performance. For instance, weather phenomena such as rain, fog, snow, and glare, as well as contaminants like dirt, ice, or condensation, can obstruct a camera's optical path, which causes blockage in a field of view of a sensing device/sensor and thereby resulting in diminished image quality or inaccurate detections. Similarly, the presence of glare from direct sunlight or headlights can cause blockage in the field of view of the sensing device/sensor and can significantly impair the sensing device's ability to provide reliable data for downstream applications.

Existing solutions address some aspects of camera blockage detection by employing algorithms to identify obstructed regions within the camera's field of view. These methods typically rely on analysing specific image features such as edge sharpness or blur to determine whether conditions like dirt, fog, or rain are present. Based on this analysis, certain actions can be taken, such as disabling specific sensor outputs, triggering windshield wipers, activating defogging systems, or switching to alternative sensors. However, these approaches primarily aim to manage the impact of blockage rather than address it comprehensively.

In the case of presence of blockage due to glare in the field of view of the sensing device, current techniques in the prior art focus on identifying its presence and signalling downstream algorithms to ignore the affected frames, as the blockage due to glare can significantly degrade object detection and recognition accuracy. However, there are no effective solutions to mitigate the impact of blockage due to glare or improve the performance of object detection and recognition in its presence.

Thus, there is a need for an improved solution that is capable of solving the aforementioned problems of conventional blockage detection techniques.

### SUMMARY OF THE INVENTION

Though blockage detection solutions are widely known in the prior art, however, existing solutions are not efficient as they are more intended towards preventing or eliminating cleanable blockages. Furthermore, the existing solutions require deletion of the image frames that include non-cleanable blockages. Furthermore, the existing solutions require multiple cameras that may be disposed at different locations of a vehicle to cover larger field of view in case of non-cleanable blockages. The larger number of cameras complicates the overall structure of the blockage detection solution/system.

Therefore, there is a need for an improved system and method for preventing blockage in the field of view of a sensing device while capturing vision data from the sensing device.

An aspect of the present disclosure aims to provide a system for prevention of a blockage in a field of view in capturing visual data. Another aspect of the present disclosure is a method for preventing a blockage in a field of view while capturing visual data.

This and other aspects are achieved by means of a system, and a method defined in the appended claims. The term exemplary is in the present context to be understood as serving as an instance, example or illustration.

According to an aspect of the present disclosure, a method for preventing a blockage in a field of view while capturing visual data is disclosed. The method comprises a step of detecting the blockage in the field of view of a sensing device when the sensing device captures the visual data. The method further comprises a step of determining a plurality of attributes associated with the blockage. The method further comprises a step of determining an image planar adjustment action based on at least one attribute of the plurality of attributes. The image planar adjustment action comprises an image planar adjustment and an image planar non-adjustment based on a threshold range associated with the at least one attribute.

Optionally, the image planar adjustment action comprises the image planar adjustment when the at least one attribute is beyond the threshold range associated with the at least one attribute. The image planar adjustment action comprises the image planar non-adjustment when the at least one attribute is within the threshold range.

Optionally, the method further comprises a step of generating an actuation signal when the image planar adjustment action comprises the image planar adjustment. The method further comprises a step of changing the field of view of the sensing device in response to the image planar adjustment.

Optionally, the method further comprises a step of generating a null signal when the image planar adjustment action comprises the image planar non-adjustment. The method further comprises a step of unaltering the field of view of the sensing device in response to the image planar non-adjustment.

Optionally, upon the image planar adjustment, an orientation of the sensing device is adjusted to change the field of view of the sensing device.

Optionally, the blockage comprises one of, a blockage due to glare in the field of view and a blockage due to a dimness in the field of view.

Optionally, the plurality of attributes comprises at least one of, coordinates of the blockage in the field of view and an intensity of the blockage.

Optionally, the method further comprises a step of comparing the field of view of the sensing device without the image planar adjustment with a changed field of view of the sensing device in response to the image planar adjustment. The method further comprises a step of determining, based on the comparison, a change in blockage between the field of view and the changed field of view. The method further comprises a step of constructing an updated field of view based on the determined change in the blockage.

According to another aspect of the present disclosure, a system for prevention of a blockage in a field of view in capturing visual data is disclosed. The system comprises processing circuitry that is configured to detect the blockage in the field of view of a sensing device when the sensing device captures the visual data. The processing circuitry is further configured to determine a plurality of attributes associated with the blockage. The processing circuitry is further configured to determine an image planar adjustment action based on at least one attribute of the plurality of attributes. The image planar adjustment action comprises an image planar adjustment and an image planar non-adjustment based on a threshold range associated with the at least one attribute.

Optionally, the image planar adjustment action comprises the image planar adjustment when the at least one attribute is beyond the threshold range associated with the at least one attribute. The image planar adjustment action comprises the image planar non-adjustment when the at least one attribute is within the threshold range.

Optionally, the processing circuitry is further configured to generate an actuation signal when the image planar adjustment action comprises the image planar adjustment. The processing circuitry is further configured to change the field of view of the sensing device in response to the image planar adjustment.

Optionally, the processing circuitry is further configured to generate a null signal when the image planar adjustment action comprises the image planar non-adjustment. The processing circuitry is further configured to unalter the field of view of the sensing device in response to the image planar non-adjustment.

Optionally, the blockage comprises one of, a blockage due to glare in the field of view and a blockage due to a dimness in the field of view.

Optionally, the plurality of attributes comprises at least one of, coordinates of the blockage in the field of view and an intensity of the blockage.

Optionally, the processing circuitry is further configured to compare the field of view of the sensing device without the image planar adjustment with a changed field of view of the sensing device in response to the image planar adjustment. The processing circuitry is further configured to determine, based on the comparison, a change in the blockage between the field of view and the changed field of view. The processing circuitry is further configured to construct an updated field of view based on the determined change in the blockage.

According to another aspect of the present disclosure, there is provided a computer program comprising instructions, which, when loaded and run on a system, causes processing circuitry to perform corresponding steps of the method for preventing a blockage in a field of view while capturing visual data.

According to another aspect of the present disclosure, there is provided a computer-readable medium having stored thereon a computer program.

Some embodiments disclosed herein have one or more of the following advantages:
With the proposed solution, a non-cleanable blockage is effectively detected and prevented from the field of view of an sensing device.
The proposed system and method advantageously facilitate active image plane adjustment that effectively eliminates the blockage from the field of view of the sensing device.
By the active image plane adjustment, the proposed system and method advantageously ensure that important information such as objects, traffic signs, overhead signs, tunnels, bridges on road is considered while processing any kind of visual data captured by the sensing device.
The proposed system and method advantageously facilitate to triangulate position of the non-cleanable blockage in the field of view such that the sensing device is actuated in a suitable direction to eliminate the blockage from the field of view of the sensing device.
The proposed system and method advantageously facilitate tilting/tipping the sensing device in a suitable direction to eliminate the blockage from the field of view, therefore there is no need for multiple cameras as being used in prior art technologies.
The proposed system and method advantageously provide dynamic adjustment of field of view of the sensing device that facilitates to increase coverage of the field of view. Thus, the sensing device efficiently detects the nearby objects that are present near to a vehicle.
The proposed system and method advantageously facilitate changing an orientation of the sensing device in one or more directions to eliminate the blockage from the field of view of the and increase the field of view of the sensing device. Thus, the proposed system and method advantageously facilitate dynamic adjustment of the field of view, which increase the coverage of the field of view of the sensing device.
The proposed system and method require a microelectromechanical system (MEMS) actuator that enhances performance of deviceless access to the vehicle.
The MEMS actuator advantageously facilitates the sensing device to move in multiple directions that eliminates the non-cleanable blockage from the field of view and also increases the field of view of the sensing device. Therefore, the sensing device is advantageously configured to capture the visual data corresponding to an updated field of view, which is clearer than the vision data of the field of view with the non-cleanable blockage.
The MEMS actuator facilitates the sensing device to pitch, yaw, roll, and X&Y translation. Thus, the MEMS actuator advantageously allows the sensing device to move in multiple directions to effectively eliminate or mitigate the effect of the non-cleanable blockage in the field of view of the sensing device.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a block diagram of a system for prevention of a blockage in a field of view in capturing visual data, according to some embodiments;

FIG. 2 illustrates a block diagram of processing circuitry of the system as illustrated in FIG. 1, according to some embodiments;

FIG. 3 illustrates a flowchart of a method for preventing a blockage in a field of view in capturing visual data, according to some embodiments;

FIG. 4A illustrates a perspective view of a sensing device and an actuator used for prevention of the blockage, according to some embodiments;

FIG. 4B illustrates a side schematic view of an image sensor of the sensing device and the actuator, according to some exemplary embodiments;

FIG. 4C illustrates a top schematic view of the image sensor of the sensing device and the actuator, according to some exemplary embodiments;

FIG. 5A and FIG. 5B illustrate a zoomed view of section A-A of FIG. 4C, according to some exemplary embodiments;

FIG. 6 illustrates a flowchart of method for preventing a blockage in the field of view in capturing visual data, according to some exemplary embodiments;

FIG. 7 illustrates a field of view of the sensing device with the blockage, according to some exemplary embodiments;

FIG. 8A and FIG. 8B illustrate actuation of the sensing device, according to some exemplary embodiments; and

FIG. 9 illustrates an example computing environment implementing the system, according to some embodiments.

### DETAILED DESCRIPTION

Aspects of the present disclosure will be described more fully hereinafter with reference to the accompanying drawings. The systems and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

The terms “tilt” and “tip” may be interchangeably used herein context of the present disclosure. Further, the terms “tilting” and “tipping” may be interchangeably used herein context of the present disclosure.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a system and a method, it may also be embodied in one or more processors and one or more memories coupled to the one or more processors, wherein the one or more memories store one or more programs that perform the steps, services and functions disclosed herein when executed by the one or more processors.

As mentioned, there remains a need to provide an efficient blockage detection technique. Accordingly, the present disclosure provides a system and a method for prevention of a blockage in the field of view of an sensing device. The present disclosure provides a novel approach to detect and address environmental and physical blockages affecting cameras and other sensors, such as LIDAR, in real time. By leveraging an advanced algorithmic framework, the system and method of the present disclosure not only enhances the accuracy of detecting and categorizing obstructions but also proposes corrective actions to improve object detection and recognition under challenging conditions, including glare. Thus, the system and method of the present disclosure offers a significant improvement over existing technologies, ensuring greater reliability and safety in ADAS applications.

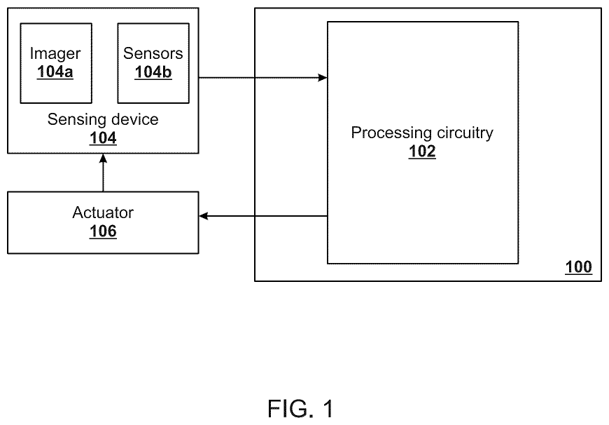

FIG. 1 illustrates a block diagram of a system 100 for prevention of a blockage in a field of view in capturing visual data, according to some embodiments. The system 100 may be deployed or implemented in a vehicle for prevention of the blockage in the field of view. The system 100 may advantageously facilitate to eliminate the blockage from the field of view. Thus, the system 100 may advantageously facilitate a sensing device 104 to capture a clear visual data of an ambience of the vehicle. The system 100 may employ an active image plane adjustment technique that advantageously solves the problems faced in the existing solutions. The active image plane adjustment technique may advantageously facilitate to triangulate the blockage in the field of view and actuate the sensing device 104 in a suitable direction such that the blockage is eliminated or reduced from the field of view. The sensing device 104 may be placed on an actuator that facilitates active image plane adjustment for the sensing device 104 such that the blockage is now reduced or eliminated from the field of view of the sensing device 104.

The system 100 may comprise processing circuitry 102. The sensing device 104 may be configured to capture the visual data. The processing circuitry 102 may be configured to detect the blockage in the field of view of an sensing device 104 while the sensing device 104 captures the visual data. The processing circuitry 102 may be further configured to determine a plurality of attributes associated with the blockage. The processing circuitry 102 may be further configured to determine an image planar adjustment action based on at least one attribute of the plurality of attributes. The image planar adjustment action may comprise an image planar adjustment and an image planar non-adjustment based on a threshold range associated with the at least one attribute of the plurality of attributes.

In some embodiments of the present disclosure, the sensing device 104 may include one of, an imager 104a and sensors 104b. The imager 104a may be a camera that may be configured to capture the visual data. The sensors 104b may be Light Detection and Ranging sensors and Radio Detection and Ranging sensors. The Light Detection and Ranging sensors and the Radio Detection and Ranging sensors may be configured to capture the visual data. Embodiments of the present disclosure are intended to include and/or otherwise cover any kind of known and later developed sensor, camera, and imager as a part of the sensing device 104, without deviating from the scope of the present disclosure.

In some embodiments of the present disclosure, the image planar adjustment action may comprise the image planar adjustment when the at least one attribute is beyond the threshold range associated with the at least one attribute. The image planar adjustment action may comprise the image planar non-adjustment when the at least one attribute is within the threshold range.

In some examples of the present disclosure, the at least one attribute may be a saturation level of pixels near to the blockage. In other words, the at least one attribute may be the saturation level of the pixels around glare area/region. Thus, the threshold range may be from 200 to 255. In some examples of the present disclosure, the at least one attribute may be spot size of pixels having a certain high signal level alongside a gradient indicative of a ghost.

In some embodiments of the present disclosure, the processing circuitry 102 may be further configured to generate an actuation signal when the image planar adjustment action comprises the image planar adjustment. In some embodiments of the present disclosure, the processing circuitry 102 may be further configured to change the field of view of the sensing device 104 in response to the image planar adjustment.

In some examples of the present disclosure, upon the image planar adjustment, an orientation of the sensing device 104 may be adjusted by way of an actuator 106. The actuator 106 may be configured to adjust the orientation of the sensing device 104 to change the field of view of the sensing device 104. The sensing device 104 may be coupled to the actuator 106. Specifically, the sensing device 104 may be disposed on the actuator 106. The actuator 106 may be configured to tilt or tip the sensing device 104 upon generation of the actuation signal to adjust the orientation of the sensing device 104. In some examples of the present disclosure, the actuator 106 may be adapted to adjust the orientation of the sensing device 104 in a range of 0.1 Degrees to 20 Degrees. Preferably, the actuator 106 may be adapted to adjust the orientation of the sensing device 104 in the range of 0.1 Degree to 1 Degree.

In some examples of the present disclosure, the actuator 106 may comprise a microelectromechanical system (MEMS) actuator. The MEMS actuator may be based on a comb drive. The comb drive of the MEMS actuator are capacitive actuators that utilize electrostatic forces. The electrostatic forces acting between two electrically conductive combs. The combs are arranged such that the combs never touch to each other. When voltage is applied, the voltage causes the combs to be drawn together, causing mechanical movement. The force (mechanical movement) is proportional to the square of the applied voltage between the combs.

In an example, the MEMS actuator may actuate the sensing device 104 in multiple directions. For example, the MEMS actuator may be configured to facilitate the sensing device 104 to exhibit pitching, yawing, rolling, and X&Y translation. The MEMS actuator may be advantageously configured to provide 5-axis stabilization. The MEMS actuator may respond very quickly upon generation of the actuation signal. In other words, the MEMS actuator may be configured to quickly change the orientation of the sensing device 104 with reduced latency, whenever required. Preferably, the MEMS actuator may be configured to quickly change the orientation of sensing device 104 between time stamps corresponding to capturing of visual data associated to consecutive image frames to avoid introduction of motion blur. Embodiments of the present disclosure are intended to include and/or otherwise cover any type of actuator, without deviating from the scope of the present disclosure.

In some embodiments of the present disclosure, the processing circuitry 102 may be configured to generate a null signal when the image planar adjustment action comprises the image planar non-adjustment. In some embodiments of the present disclosure, the processing circuitry 102 may be further configured to unalter the field of view of the sensing device 104 in response to the image planar non-adjustment.

In some embodiments of the present disclosure, the blockage may be a non-cleanable blockage. For example, the blockage may not be any blockage caused due to soiling, dirt, fog, and the like. The blockage may comprise one of, a blockage due to glare in the field of view and a blockage due to a dimness in the field of view. The glare may be produced by virtue of one of, sun/sunlight, headlight of another vehicle that may produce high beam or low beam. Embodiments of the present disclosure are intended to include and/or otherwise cover any kind of source of the glare that may cause the blockage in the field of view of the sensing device 104, without deviating from the scope of the present disclosure.

In some embodiments of the present disclosure, the blockage may be caused due to internal reflections (for example, flare or ghost) in one or more components of the sensing device 104. For example, the blockage may be caused due to internal reflections between lens of the sensing device 104 and surface of an image sensor of the sensing device 104.

In some embodiments of the present disclosure, the plurality of attributes may comprise at least one of, co-ordinates of the blockage in the field of view and an intensity of the blockage. Embodiments of the present disclosure are intended to include and/or otherwise cover any type of inherent property of the blockage as one of the attributes of the plurality of attributes, without deviating from the scope of the present disclosure.

In some embodiments of the present disclosure, the processing circuitry 102 may be further configured to compare the field of view of the sensing device 104 without the image planar adjustment with a changed field of view of the sensing device 104 in response to the image planar adjustment. The processing circuitry 102 may be further configured to determine, based on the comparison, a change in the blockage between the field of view and the changed field of view. The processing circuitry 102 may be further configured to construct an updated field of view based on the determined change in the blockage.

In some examples of the present disclosure, the processing circuitry 102 may be configured to extract information from the field of view. The processing circuitry 102 may be further configured to determine degree of importance for the information from the field of view. The degree of importance may comprise a positive value and a negative value. The degree of importance may be a measure of importance of the information from the field of view. In other words, the degree of importance may be indicative of whether the information from the field of view is important or not. The degree of importance may comprise the positive value when the information from the field of view is important and the degree of importance may comprise the negative value when the information from the field of view is not important. The processing circuitry 102 may be configured to construct the updated field of view based on the degree of importance. Specifically, the processing circuitry 102, to construct the updated field of view, may require the field of view and the changed field of view when the degree of importance comprises the positive value i.e., when the information from the field of view is important. In such a scenario, the processing circuitry 102 may be configured to construct the updated field of view by overlapping the field of view with the changed field of view. In some examples of the present disclosure, the processing circuitry 102, to construct the updated field of view, may employ various fusion techniques to overlap/fuse/combine the field of view with the changed field of view. In some other examples of the present disclosure, the processing circuitry 102, to construct the updated field of view, may be configured to employ various stitching techniques to stitch the field of view with the changed field of view. Embodiments of the present disclosure are intended to include and/or otherwise cover any type of technique to construct the updated field of view based on the field of view and the changed field of view, without deviating from the scope of the present disclosure. In a different scenario, the processing circuitry 102, to construct the updated field of view, may require the changed field of view when the degree of importance comprises the negative value i.e., when the information from the field of view is not important. In such a scenario, the processing circuitry 102 may be configured to construct the updated field of view based on the changed field of view. In other words, the changed field of view may be the updated field of view.

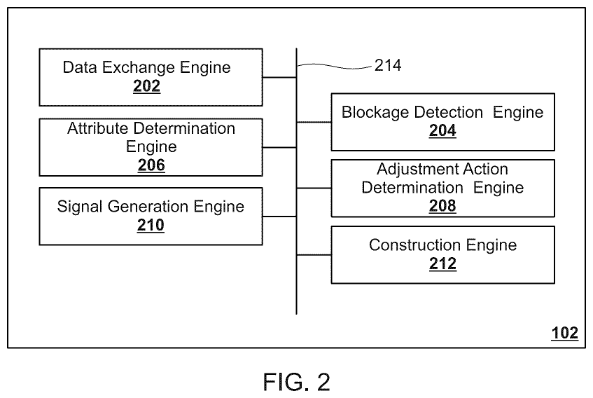

FIG. 2 illustrates a block diagram of processing circuitry 102 of the system as illustrated in FIG. 1, according to some embodiments. The processing circuitry 102 may include one or more engines that may be configured to execute one or more functionalities associated with the system 100. Each engine of the one or more engines of the processing circuitry 102 may be a set of instructions that, when executed by hardware circuitry of the processing circuitry 102, may be configured to perform a specific functionality of the system 100.

The processing circuitry 102 may comprise a data exchange engine 202, a blockage detection engine 204, an attribute determination engine 206, an adjustment action determination engine 208, a signal generation engine 210, and a construction engine 212. The data exchange engine 202, the blockage detection engine 204, the attribute determination engine 206, the adjustment action determination engine 208, the signal generation engine 210, and the construction engine 212 may be communicatively coupled to each other. Specifically, the data exchange engine 202, the blockage detection engine 204, the attribute determination engine 206, the adjustment action determination engine 208, the signal generation engine 210, and the construction engine 212 may be communicatively coupled to each other by way of a communication channel 214. The communication channel 214 may be one of, a wired communication channel and a wireless communication channel. Embodiments of the present disclosure are intended to include and/or otherwise cover any type of the communication channel 214, without deviating from the scope of the present disclosure.

The data exchange engine 202 may facilitate the processing circuitry 102 to exchange data associated with the system 100 among various engines of the processing circuitry 102. Specifically, the data exchange engine 202 may facilitate the processing circuitry 102 to exchange the data among various engines by way of the communication channel 214. The communication channel 214 may be any type of the communication channel that may facilitate exchange of information between the engines of the processing circuitry 102.

The blockage detection engine 204 may be configured to facilitate the processing circuitry 102 to detect the blockage in the field of view of the sensing device 104. Specifically, the blockage detection engine 204 may be configured to facilitate the processing circuitry 102 to detect the blockage in the field of view of the sensing device 104 while the sensing device 104 captures the visual data. The blockage may be the non-cleanable blockage. For example, the blockage may not be any blockage caused due to soiling, dirt, fog, and the like. The blockage may comprise one of, the blockage due to glare in the field of view and the blockage due to dimness in the field of view.

The attribute determination engine 206 may be configured to facilitate the processing circuitry 102 to determine the plurality of attributes associated with the blockage. The plurality of attributes may comprise at least one of, the co-ordinates of the blockage in the field of view and the intensity of the blockage in the field of view.

The adjustment action determination engine 208 may be configured to facilitate the processing circuitry 102 to determine the image planar adjustment action. Specifically, the adjustment action determination engine 208 may be configured to facilitate the processing circuitry 102 to determine the image planar adjustment action based on the at least one attribute of the plurality of attributes. The image planar adjustment action may comprise an image planar adjustment and an image planar non-adjustment based on threshold range associated with the at least one attribute of the plurality of attributes. The image planar adjustment action may comprise the image planar adjustment when the at least one attribute is beyond the threshold range associated with the at least one attribute. The image planar adjustment action may comprise the image planar adjustment when the at least one attribute is within the threshold range.

The signal generation engine 210 may be configured to facilitate the processing circuitry 102 to generate the actuation signal when the image planar adjustment action comprises the image planar adjustment. The signal generation engine 210 may be further configured to facilitate the processing circuitry 210 to change the field of view of the sensing device 104 in response to the image planar adjustment. The signal generation engine 210 may be further configured to facilitate the processing circuitry 102 to generate the null signal when the image planar adjustment action comprises the image planar non-adjustment. The signal generation engine 210 may be further configured to facilitate the processing circuitry 102 to unalter the field of view of the sensing device 104 in response to the image planar non-adjustment.

The construction engine 212 may be configured to facilitate the processing circuitry 102 to compare the field of view of the sensing device 104 without the image planar adjustment with the changed field of view of the sensing device 104 in response to the image planar adjustment. The construction engine 212 may be further configured to facilitate the processing circuitry 102 to determine, based on the comparison, a change in the blockage between the field of view and the changed field of view. The construction engine 212 may be further configured to facilitate the processing circuitry 102 to construct the updated field of view based on the determined change in the blockage.

In some examples of the present disclosure, the construction engine 212 may be configured to facilitate the processing circuitry 102 to extract the information from the field of view. The construction engine 212 may be further configured to facilitate the processing circuitry 102 to determine the degree of importance for the information from the field of view. The construction engine 212 may be further configured to facilitate the processing circuitry 102 to construct the updated field of view based on the degree of importance. Specifically, the construction engine 212 may be further configured to facilitate the processing circuitry 102 to construct the updated field of view by overlapping the field of view with the changed field of view when the degree of importance comprises the positive value i.e., when the information from the field of view is important. The construction engine 212 may be further configured to facilitate the processing circuitry 102 to construct the updated field of view based on the changed of field of view when the degree of importance comprises the negative value i.e., when the information from the field of view is not important.

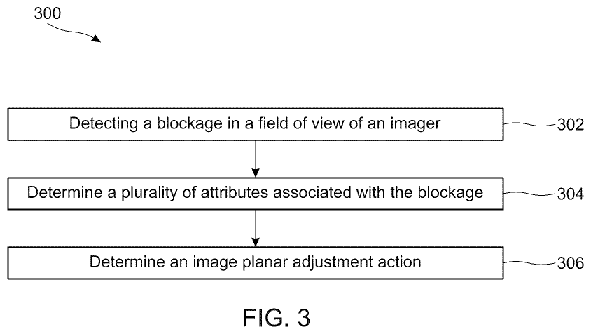

FIG. 3 illustrates a flowchart of a method 300 for preventing the blockage in the field of view while capturing visual data. The method 300 may comprise following steps for preventing the blockage in the field of view by way of the system 100 as shown in FIG. 1.

At step 302, the method 300 may comprise a step of detecting the blockage in the field of view (FOV) of the sensing device 104. Specifically, the method 300 may comprise the step of detecting the blockage in the field of view of the sensing device 104 when the sensing device 104 captures the visual data. The blockage may comprise the blockage due to glare in the field of view and the blockage due to a dimness in the field of view.

At step 304, the method 300 may comprise a step of determining the plurality of attributes associated with the blockage. The plurality of attributes comprises at least one of, co-ordinates of the blockage in the field of view and the intensity of the blockage.

At step 306, the method 300 may comprise a step of determining the image planar adjustment action. Specifically, the method 300 may comprise the step of determining the image planar adjustment action based on at least one attribute of the plurality of attributes. The image planar adjustment action comprises the image planar adjustment and the image planar non-adjustment based on the threshold range associated with the at least one attribute.

Details of the method 300 are similar to the details of the system 100 as discussed above and hence are not repeated for the sake of brevity.

In some embodiments of the present disclosure, the image planar adjustment action comprises the image planar adjustment when the at least one attribute is beyond the threshold range associated with the at least one attribute. The image planar adjustment action comprises the image planar non-adjustment when the at least on attribute is within the threshold range.

In some embodiments of the present disclosure, the method 300 may further comprise a step of generating the actuation signal when the image planar adjustment action comprises the image planar adjustment. The method 300 may further comprise a step of changing the field of view of the sensing device 104 in response to the image planar adjustment.

In some embodiments of the present disclosure, the method 300 may further comprise a step of generating the null signal when the image planar adjustment action comprises the image planar non-adjustment. The method 300 may further comprise a step of unaltering the field of view of the sensing device 104 in response to the image planar non-adjustment.

In some embodiments of the present disclosure, upon the image planar adjustment, the orientation of the sensing device 104 may be adjusted. Specifically, upon the image planar adjustment, the orientation of the sensing device 104 may be adjusted to change the field of view of the sensing device 104.

In some embodiments of the present disclosure, the method 300 may further comprise a step of comparing the field of view of the sensing device 104 without the image planar adjustment with the changed field of view of the sensing device 104 in response to the image planar adjustment. The method 300 may further comprise the step of determining, based on the comparison, the change in the blockage between the field of view and the changed field of view. The method 300 may further comprise the step of constructing the updated field of view based on the determined change in the blockage.

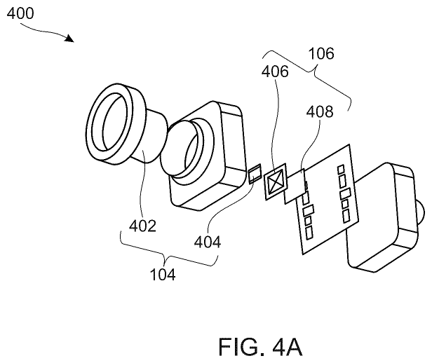

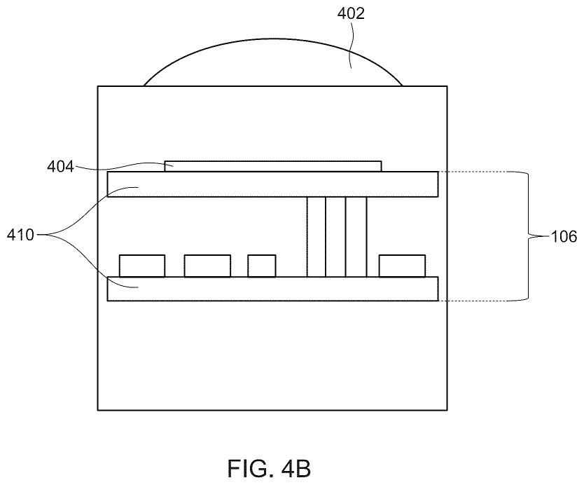

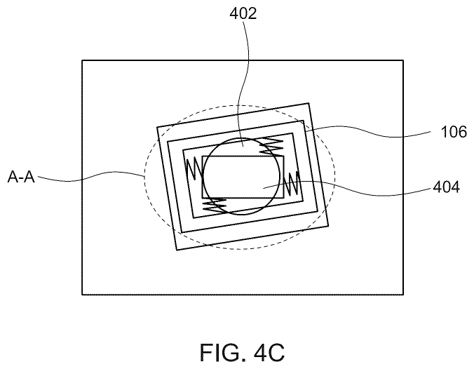

FIG. 4A illustrates a perspective view 400 of the sensing device 104 and the actuator 106 used for prevention of the blockage, according to some embodiments. The sensing device 104 may comprise an optical lens assembly 402 and an image sensor 404. The actuator 106 may comprise a stage 406 and a frame 408.

In some embodiments of the present disclosure, the optical lens assembly 402 may include one or more optical lenses (not shown). The one or more optical lenses may be stacked in an arrangement that the one or more lenses facilitates the sensing device 104 to capture the clear visual data. The arrangement of the one or more optical lenses may be adjusted to adjust resolution associated with the field of view of the sensing device 104.

In some embodiments of the present disclosure, the image sensor 404 may be disposed behind the optical lens assembly 402 when seen from a side of an object/user that may be captured in the visual data. The image sensor 404 may be disposed behind the optical lens assembly 402 such that the image sensor 404 may be configured to sense signals associated with the visual data captured by the image sensor 404. Since, the one or more optical lenses are arranged to provide clear focus and clear resolution, therefore, the image sensor 404 is configured to capture clear visual data that shows clear visibility of the field of view of the sensing device 104.

In some embodiments of the present disclosure, the sensing device 104 may be disposed on the stage 406. Specifically, the image sensor 404 may be disposed on the stage 406. The stage 406 may be supported on or carried by the frame 408. The stage 406 and the frame 408 forms the part of the actuator 106. The stage 406 may be configured to actuate upon generation of the actuation signal. The stage 406 may be configured to tilt at the one or more angles such that an orientation of the stage 406 may be changed upon generation of the actuation signal. The stage 406 may therefore facilitate to change the orientation of the image sensor 404 upon generation of the actuation signal. Specifically, to dynamically adjust the field of view of the sensing device 104, the stage 406 may facilitate to change the orientation of the image sensor 404. In other words, the stage 406 may be configured to tilt at the one or more angles, consequently, changing the orientation of the image sensor 404 in the one or more directions. This facilitates adjustment of the field of view of the sensing device 104 in the one or more directions.

FIG. 4B illustrates a side schematic view of the image sensor 404 of the sensing device 104 and the actuator 106, according to some exemplary embodiments. FIG. 4C illustrates a top schematic view of the image sensor 404 of the sensing device 104 and the actuator 106, according to some exemplary embodiments.

The sensing device 104 may be disposed on the actuator 106. In some examples of the present disclosure, the actuator 106 may be a four-channel MEMS driver. In some other examples of the present disclosure, the actuator 106 may be a four-corner tilt type actuator. The actuator 106 may further comprise Printed Circuit Boards (PCBs) 410. The PCBs 410 may be configured to electrically support one or more electrical components of the actuator 106. The PCBs 410 may have a square cross-sectional shape. Embodiments of the present disclosure are intended to include and/or otherwise cover any type of the shape of the PCBs 410, without deviating from the scope of the present disclosure. The PCBs 410 may have a length that may be in a range of 20 millimetres (mm) to 30 mm. The PCBs 410 may have a width that may be in a range of 20 mm to 30 mm. Preferably, the PCBs 410 may have the length that may be 22 mm, and the PCBs 410 may have the width that may be 22 mm. Embodiments of the present disclosure are intended to include and/or otherwise cover any dimensional value i.e., length value and width value, without deviating from the scope of the present disclosure.

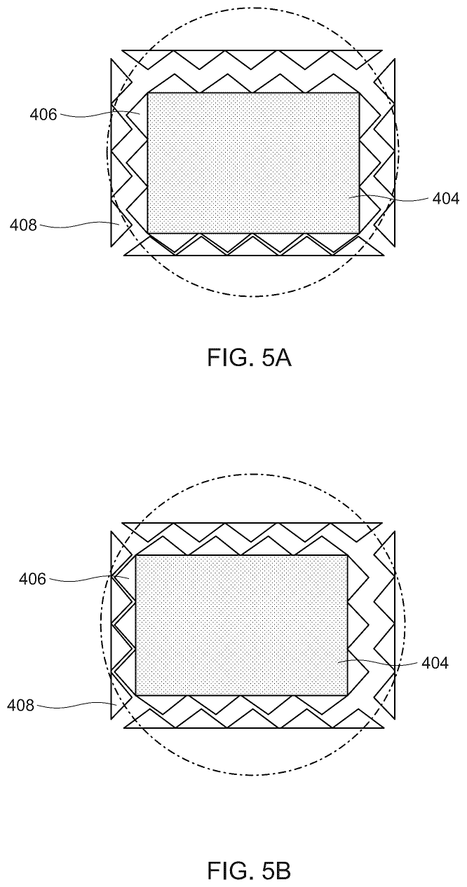

FIG. 5A and FIG. 5B illustrate a zoomed view of section A-A of FIG. 4C, according to some exemplary embodiments. FIG. 5A and FIG. 5B show the image sensor 404 being disposed on the stage 406 and the stage 406 being supported on the frame 408. Specifically, FIG. 5A shows the stage 406 carrying the image sensor 404 being moved away from the frame 408 i.e., in an upward direction. The actuator 106 may be adapted to adjust the orientation of the sensing device 104 such that the stage 406 carrying the image sensor 404 is moved away from the frame 408 i.e., in the upward direction. Specifically, FIG. 5B shows the stage 406 carrying the image sensor 404 being moved towards the frame 408 i.e., in a downward direction. The actuator 106 may be adapted to adjust the orientation of the sensing device 104 such that the stage 406 carrying the image sensor 404 is moved towards the frame 408 i.e., in the downward direction.

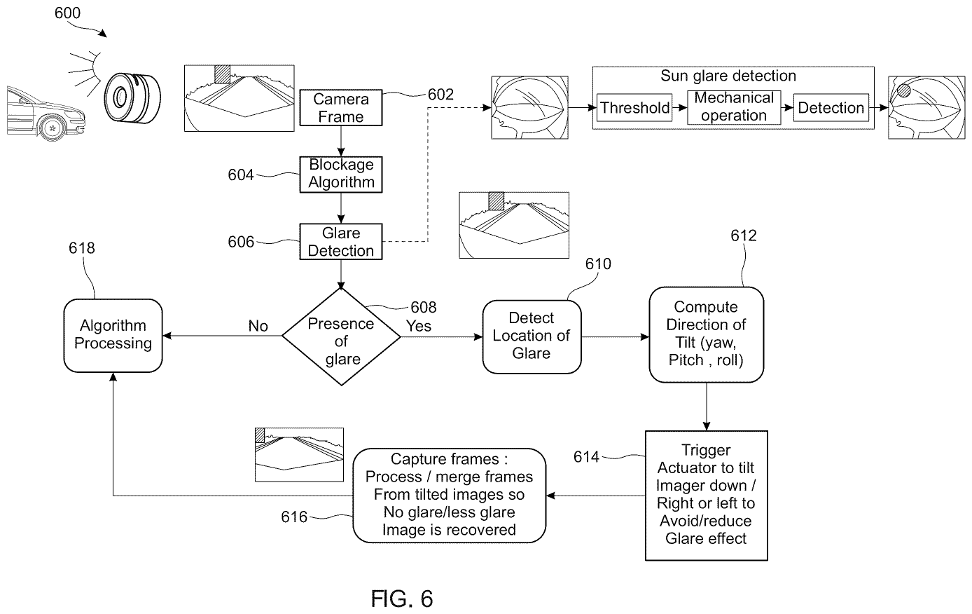

FIG. 6 illustrates a flowchart of method 600 for preventing the blockage in the field of view in capturing the visual data, according to some exemplary embodiments. The method 600 may include following steps for prevention of the blockage in the field of view in capturing the visual data.

At step 602, the sensing device 104 may be configured to capture the visual data. Specifically, the sensing device 104 may be configured to capture the visual data corresponding to the field of view of the sensing device 104. The sensing device 104 may be disposed at any suitable location of a vehicle. Specifically, the sensing device 104 may be disposed at a location that may cover maximum area/region around the vehicle.

At step 604, the processing circuitry 102 may be configured to receive the visual data from the sensing device 104. The processing circuitry 102 may be configured to process the visual data. In some embodiments of the present disclosure, the processing circuitry 102 may be configured to perform one or more image enhancement techniques on the visual data. The one or more image enhancement techniques may facilitate to better or clearly recognize the visual data. The processing circuitry 102, upon receipt of the visual data from the sensing device 104, may be configured to initiate a blockage detection algorithm. The initiation of the blockage detection algorithm may facilitate the processing circuitry 102 to detect the blockage that may be present in the field of view of the sensing device 104. The processing circuitry 102 may be further configured to classify the blockage that may be detected in the field of view. Specifically, the processing circuitry 102 may be configured to classify the blockage as a cleanable blockage and a non-cleanable blockage. The term “cleanable blockage” as used herein refers to a blockage that may be wiped out by a cloth or any other suitable means. Generally, these types of blockages in the field of view may occur due to presence of an obstructive element, such as, dirt, dust, fog, and the like on the surface of the sensing device 104. The term “non-cleanable blockage” as used herein refers to a blockage that may not be wiped out by the cloth or any other suitable means. Generally, these types of blockages in the field of view may occur due to natural blockages, such as, high amount of light around the sensing device 104. The non-cleanable blockage may include one of, the blockage due to the glare (hereinafter referred to as “glare”) and the blockage due to the dimness.

At step 606, the processing circuitry 102 may be configured to classify the blockage as the non-cleanable blockage. The processing circuitry 102 may be configured to classify the blockage as the non-cleanable blockage. Specifically, the processing circuitry 102 may be configured to classify the blockage as the glare. The glare may be caused due to brightness from the sun. In other words, the glare may be caused due to high light intensity region that may be present around the sensing device 104.

At step 608, the processing circuitry 102 may be configured to determine an intensity associated with the glare. The processing circuitry 102 may be configured to compare the intensity of the glare with a threshold range of the intensity. The processing circuitry 102 may be configured to determine whether (i) the intensity of the glare is beyond the threshold range of the intensity or (ii) the intensity of the glare is within the threshold range of the intensity.

At step 610, the processing circuitry 102 may be configured to determine location of the glare in the field of view of the sensing device 104. Specifically, the processing circuitry 102 may be configured to determine the location of the glare in the field of view of the sensing device 104 when the intensity of the glare is beyond the threshold range of the intensity.

At step 612, the processing circuitry 102 may be configured to determine a plurality of directions of tilt for the actuator 106. Specifically, the processing circuitry 102 may be configured to determine the plurality of directions of tilt based on the location of the glare in the field of view of the sensing device 104. The plurality of directions of tilt may include one of, yaw, pitch, and roll. Embodiments of the present disclosure are intended to include and/or otherwise cover any direction of tilt for the actuator 106, without deviating from the scope of the present disclosure.

At 614, the processing circuitry 102 may be configured to trigger the actuator 106 based on the plurality of directions of tilt. In other words, the processing circuitry 102 may be configured to generate the actuation signal. The actuator 106, upon generation of the actuation signal, may facilitate the sensing device 104 to tilt in one of the plurality of directions of tilt. In some examples of the present disclosure, the actuator 106, upon generation of the actuation signal, may facilitate the sensing device 104 to tilt in one of, a downward direction, an upward direction, a left direction, and a right direction. In some other examples of the present disclosure, the actuator 106, upon generation of the actuation signal, may facilitate the sensing device 104 to exhibit one of, pitching, yawing, and rolling motions. The actuator 106, upon tilting/tipping the sensing device 104 in one of the plurality of directions, may facilitate the sensing device 104 to change the field of view. In other words, the sensing device 104, upon being tilted in one of the plurality of directions by the actuator 106, may exhibit a changed field of view. The changed field of view of the sensing device 104 may have a reduced glare or no glare. Thereby, the tilting of the sensing device 104 in one of the plurality of directions advantageously eliminate or mitigate effect of the glare in the field of view of the sensing device 104.

At step 616, the sensing device 104 may be configured to capture the visual data associated with the changed field of view. The visual data corresponding to the changed field of view may be clearer as the changed field of view does not include the glare. The processing circuitry 102 may be configured to construct the updated field of view based on the degree of importance. In one scenario, the processing circuitry 102 may be configured to construct the updated field of view by overlapping the field of view with the changed field of view. The processing circuitry 102, to construct the updated field of view, may employ various fusion techniques to overlap/fuse/combine the field of view with the changed field of view. In some other examples, the processing circuitry 102, to construct the updated field of view, may be configured to employ various stitching/aligning/merging techniques to stitch/overlap/fuse the field of view with the changed field of view. In another scenario, the processing circuitry 102 may be configured to construct the updated field of view based on the changed field of view. In this scenario, the field of view may not be overlapped/fused/merged with the changed field of view and the changed field of view may be considered as the updated field of view.

At step 618, the processing circuitry 102 may be configured to process the updated field of view. Specifically, the processing circuitry 102 may be configured to process the updated field of view that may have less glare or no glare. Thus, the processing circuitry 102 may be configured to process clearer vision data associated with the updated field of view.

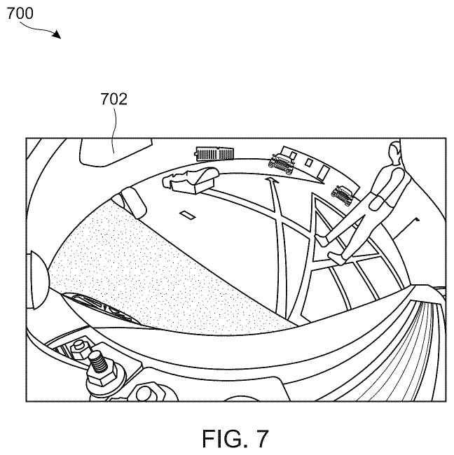

FIG. 7 illustrates a field of view 700 of the sensing device 104 with the blockage 702, according to some exemplary embodiments. The field of view 700 of the sensing device 104 may have the blockage 702 that may be present at a particular location in the field of view 700. In this example, the blockage 702 may be present near to a top left corner of the field of view 700 of the sensing device 104. Accordingly, the actuator 106 may be configured to facilitate tilting of the sensing device 104 in a direction opposite to the position of the blockage 702. Specifically, the actuator 106 may be configured to facilitate tilting of the sensing device 104 in one of, a right direction or a downward direction to eliminate or reduce the effect of the blockage 702 in the field of view 700.

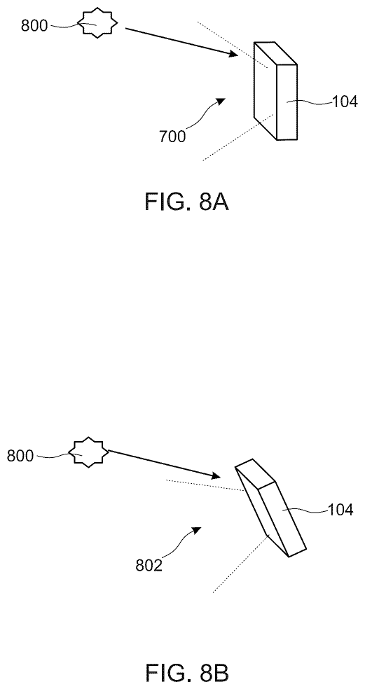

FIG. 8A and FIG. 8B illustrate actuation of the sensing device 104, according to some exemplary embodiments. FIGS. 8A and 8B show a sun 800 that imparts sunlight on the sensing device 104. Specifically, FIG. 8A shows that the sun 800 causes the non-cleanable obstruction in the field of view 700 of the sensing device 104. The sun 800 causes the glare (obstruction) in the field of view 700 of the sensing device 104. Specifically, sunrays from the sun 800 are in a direction that enters in the field of view 700 of the sensing device 104 and thereby causing the glare in the field of view 700. In FIG. 8A, the glare may be caused near to an upper side of the field of view 700, accordingly, the sensing device 104 may be tilted in a direction opposite to the upper side of the field of view 700. In other words, the sensing device 104 may be tilted to face towards downside such that the glare is eliminated from the field of view 700. FIG. 8B shows the actuation of the sensing device 104 opposite to the location of the glare in the field of view 700. Specifically, FIG. 8B shows tilt of the sensing device 104 towards downside such that the glare is now eliminated from the field of view 700 of the sensing device 104 and thereby forming the changed field of view 802. The changed field of view 802 may include less glare or no glare due to the sun 800. The changed field of view 802 may facilitate the sensing device 104 to capture clearer vision data. This tilt of the sensing device 104 towards downside and achieving the changed field of view 802 may advantageously facilitate the processing circuitry 102 to more efficiently process the vision data associated with the updated field of view. The processing circuitry 102 may be configured to construct the updated field of view based on the field of view 700 and the changed field of view 802. In one scenario, the processing circuitry 102 may be configured to construct the updated field of view by overlapping the field of view 700 with the changed field of view 802. The processing circuitry 102, to construct the updated field of view, may employ various fusion techniques to overlap/fuse/combine the field of view 700 with the changed field of view 802. In some other examples, the processing circuitry 102, to construct the updated field of view, may be configured to employ various stitching techniques to stitch the field of view 700 with the changed field of view 802. In another scenario, the processing circuitry 102 may be configured to construct the updated field of view based on the changed field of view 802. In this scenario, the field of view 700 may not be overlapped/fused/merged with the changed field of view 802 and the changed field of view 802 may be considered as the updated field of view.

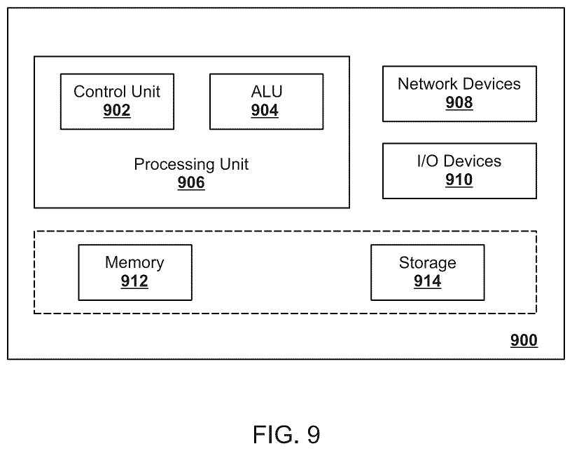

FIG. 9 illustrates an example computing environment 900 implementing the system 100, according to some embodiments. The example-computing environment 900 further implements the system 100 as shown in FIGS. 1 and 2 to prevent the blockage from the field of view the user. As depicted in FIG. 9, the computing environment 900 comprises at least one data processing unit 906 that is equipped with a control unit 902 and an Arithmetic Logic Unit (ALU) 904, a plurality of networking devices 908 and a plurality Input output, I/O devices 910, a memory 912, a storage 914. The data processing unit 906 may be responsible for implementing the system 100 and method 300 described in FIGS. 1 to 3. For example, the data processing unit 906 in some embodiments be equivalent to the processing circuitry 102 of the platform described above in conjunction with FIG. 2. For another example, the data processing unit 906 in some embodiments be equivalent to the processing circuitry of the platform described above in conjunction with FIG. 2. The data processing unit 906 is capable of executing software instructions stored in memory 912. The data processing unit 906 receives commands from the control unit 902 in order to perform its processing. Further, any logical and arithmetic operations involved in the execution of the instructions are computed with the help of the ALU 904.

The computer program is loadable into the data processing unit 906, which may, for example, be comprised in an electronic apparatus (such as the platform). When loaded into the data processing unit 906, the computer program may be stored in the memory 912 associated with or comprised in the data processing unit 906. According to some embodiments, the computer program may, when loaded into and run by the data processing unit 906, cause execution of method steps according to, for example, the method 300 illustrated in FIG. 3 as described herein.

The overall computing environment 900 may be composed of multiple homogeneous and/or heterogeneous cores, multiple CPUs of different kinds, special media and other accelerators. Further, the plurality of data processing unit 906 may be located on a single chip or over multiple chips.

The algorithm comprising of instructions and codes required for the implementation are stored in either the memory 912 or the storage 914 or both. At the time of execution, the instructions may be fetched from the corresponding memory 912 and/or storage 914 and executed by the data processing unit 906.

In case of any hardware implementations various networking devices 908 or external I/O devices 910 may be connected to the computing environment to support the implementation through the networking devices 908 and the I/O devices 910.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

### REFERENCE SIGNS

System 100
Processing circuitry 102
Sensing Device 104
Actuator 106
Data exchange engine 202
Blockage detection engine 204
Attribute determination engine 206
Adjustment action determination engine 208
Signal generation engine 210
Construction engine 212
Communication channel 214
Method 300
Optical lens assembly 402
Image sensor 404
Stage 406
Frame 408
Printed Circuit Boards (PCBs) 410
Field of view 700
Blockage 702
Sun 800
Changed field of view 802
Computing environment 900
Control unit 902
Arithmetic Logic Unit 904
Data processing unit 906
Networking devices 908
Input/output devices 910
Memory 912

1. A method for preventing a blockage in a field of view while capturing visual data, the method comprising:
detecting the blockage in the field of view of a sensing device when the sensing device captures the visual data;
determining a plurality of attributes associated with the blockage; and
determining an image planar adjustment action based on at least one attribute of the plurality of attributes,
wherein the image planar adjustment action comprises an image planar adjustment and an image planar non-adjustment based on a threshold range associated with the at least one attribute.

2. The method according to claim 1, wherein the image planar adjustment action comprises the image planar adjustment when the at least one attribute is beyond the threshold range associated with the at least one attribute and the image planar adjustment action comprises the image planar non-adjustment when the at least one attribute is within the threshold range.

3. The method according to claim 1, further comprising:
generating an actuation signal when the image planar adjustment action comprises the image planar adjustment; and
changing the field of view of the sensing device in response to the image planar adjustment.

4. The method according to claim 1, further comprising:
generating a null signal when the image planar adjustment action comprises the image planar non-adjustment; and
unaltering the field of view of the sensing device in response to the image planar non-adjustment.

5. The method according to claim 1, wherein, upon the image planar adjustment, an orientation of the sensing device is adjusted to change the field of view of the sensing device.

6. The method according to claim 1, wherein the blockage comprises one of, a blockage due to glare in the field of view and a blockage due to a dimness in the field of view.

7. The method according to claim 1, wherein the plurality of attributes comprises at least one of, co-ordinates of the blockage in the field of view and an intensity of the blockage.

8. The method according to claim 1, further comprising:
comparing the field of view of the sensing device without the image planar adjustment with a changed field of view of the sensing device in response to the image planar adjustment;
determining, based on the comparison, a change in blockage between the field of view and the changed field of view and constructing an updated field of view based on the determined change in the blockage.

9. A system for prevention of a blockage in a field of view in capturing visual data, characterized in that the system comprising:
processing circuitry configured to:
detect the blockage in the field of view of an sensing device when the sensing device captures the visual data;
determine a plurality of attributes associated with the blockage;
determine an image planar adjustment action based on at least one attribute of the plurality of attributes,
wherein the image planar adjustment action comprises an image planar adjustment and an image planar non-adjustment based on a threshold range associated with the at least one attribute.

10. The system according to claim 9, wherein the image planar adjustment action comprises the image planar adjustment when the at least one attribute is beyond the threshold range associated with the at least one attribute and the image planar adjustment action comprises the image planar non-adjustment when the at least one attribute is within the threshold range.

11. The system according to claim 9, wherein the processing circuitry is further configured to:
generate an actuation signal when the image planar adjustment action comprises the image planar adjustment; and
change the field of view of the sensing device in response to the image planar adjustment.

12. The system according to claim 9, wherein the processing circuitry is further configured to:
generate a null signal when the image planar adjustment action comprises the image planar non-adjustment; and
unalter the field of view of the sensing device in response to the image planar non-adjustment.

13. The system according to claim 9, wherein the processing circuitry is further configured to:
compare the field of view of the sensing device without the image planar adjustment with a changed field of view of the sensing device in response to the image planar adjustment;
determine, based on the comparison, a change in the blockage between the field of view and the changed field of view and construct an updated field of view based on the determined change in the blockage.

14. A computer program comprising instructions, which, when the computer program is executed by a computer, causes the computer to carry out the method of claim 1.

15. A non-transitory computer-readable medium having stored thereon the computer program of claim 14.
